(19) United States
(12) Patent Application Publication
(10) Pub. No.: US 2026/0343578 A1
(43) Pub. Date: Oct. 29, 2026

(54) APPARATUS, METHOD FOR USER EQUIPMENT, USER EQUIPMENT AND METHOD FOR NETWORK ELEMENT

(71) Applicant: Apple Inc., Cupertino, CA (US)

(72) Inventors: Qiming Li, Beijing (CN); Xiang Chen, Palo Alto, CA (US); Dawei Zhang, Saratoga, CA (US); Yang Tang, San Jose, CA (US); Jie Cui, San Jose, CA (US); Manasa Raghavan, Sunnyvale, CA (US); Haitong Sun, Saratoga, CA (US); Rolando E Bettancourt Ortega, Munich (DE); Seyed Ali Akbar Fakoorian, San Diego, CA (US); Yuexia Song, Beijing (CN)

(21) Appl. No.: 19/099,796

(22) PCT Filed: Aug. 10, 2022
(86) PCT No.: PCT/CN2022/111370

§ 371 Date: Jan. 30, 2025

(51) Int. Cl. H04W 72/51; H04W 8/24; H04W 72/23

(52) U.S. Cl. CPC H04W 72/51; H04W 8/24; H04W 72/23

(57) ABSTRACT

An apparatus is provided. The apparatus comprises: processor circuitry configured to cause a user equipment (UE) to: encode a message for transmission to a network (NW) including a UE capability information that includes an indication of a transmitting (Tx) unwanted emission capability and/or a receiving (Rx) adjacent channel selectivity (ACS)/blocking capability of the UE; transmit the message to the NW; receive a message from the NW including a scheduling information that includes an indication of an uplink (UL) resource and/or a downlink (DL) resource that is allocated to the UE; and perform a transmission according to the UL resource and/or a reception according to the DL resource, wherein the scheduling information is determined based at least on the UE capability information.

### FIELD OF THE INVENTION

The present disclosure may relate in general to a field of wireless communications, and more particularly to apparatus, methods for user equipment, user equipment and methods for network elements.

### BACKGROUND OF THE INVENTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Multiple access technologies have been adopted in various telecommunication standards to provide a common protocol that enables different wireless devices to communicate on a municipal, national, regional, and even global level. An example telecommunication standard is the 5th Generation (5G) New Radio (NR). 5G NR is part of a continuous mobile broadband evolution promulgated by the Third Generation Partnership Project (3GPP) to meet new requirements associated with latency, reliability, security, scalability (e.g., with Internet of Things (IoT)), and other requirements.

Duplex scheme implies the separation of transmission and reception or, in other words, uplink (UL) and downlink (DL) data transmission. A cellular communication system need to transmit in both UL direction and DL direction simultaneously. In order to be able to transmit in both directions, a user equipment (UE) or a base station may have a duplex scheme. To provide higher possible flexibility, 5G NR supports various duplexing schemes such as Frequency Division Duplex (FDD), Time Division Duplex (TDD), Semi-static TDD and Dynamic TDD.

### SUMMARY OF THE INVENTION

An aspect of the present disclosure mainly aims to apparatus, methods for user equipment, user equipment and methods for network elements.

In accordance with some exemplary embodiments of the present disclosure, an apparatus is provided. The apparatus may comprise: processor circuitry configured to cause a user equipment (UE) to: encode a message for transmission to a network (NW) including a UE capability information that includes an indication of a transmitting (Tx) unwanted emission capability and/or a receiving (Rx) adjacent channel selectivity (ACS)/blocking capability of the UE; transmit the message to the NW; receive a message from the NW including a scheduling information that includes an indication of an uplink (UL) resource and/or a downlink (DL) resource that is allocated to the UE; and perform a transmission according to the UL resource and/or a reception according to the DL resource, wherein the scheduling information is determined based at least on the UE capability information.

In accordance with some exemplary embodiments of the present disclosure, a method for a user equipment (UE) is provided. The method may comprise: encoding a message for transmission to a network (NW) including a UE capability information that includes an indication of a transmitting (Tx) unwanted emission capability and/or a receiving (Rx) ACS/blocking capability of the UE; transmitting the message to the NW; receiving a message from the NW including a scheduling information that includes an indication of an uplink (UL) resource and/or a downlink (DL) resource that is allocated to the UE; and performing a transmission according to the UL resource and/or a reception according to the DL resource, wherein the scheduling information is determined based at least on the UE capability information.

In accordance with some exemplary embodiments of the present disclosure, a user equipment (UE) is provided. The UE may comprise: processor circuitry configured to cause the UE to perform any one of methods in accordance with some exemplary embodiments of the present disclosure.

In accordance with some exemplary embodiments of the present disclosure, a method for a network element is provided. The method may comprise: receiving a message from a first user equipment (UE) including a UE capability information that includes an indication of a transmitting (Tx) unwanted emission capability and/or a receiving (Rx) ACS/blocking capability of the first UE; determining a first uplink (UL) resource and/or a first downlink (DL) resource that is allocated to the first UE based at least on the UE capability information; encoding a message for transmission to the first UE including a scheduling information that includes an indication of the first UL resource and/or the first DL resource; and transmitting the message to the first UE.

In accordance with some exemplary embodiments of the present disclosure, a non-transitory computer-readable memory medium is provided. The non-transitory computer-readable memory medium may store program instructions, where the program instructions, when executed by a computer system, cause the computer system to perform any one of methods in accordance with some exemplary embodiments of the present disclosure.

In accordance with some exemplary embodiments of the present disclosure, a computer program product is provided. The computer program product may comprise program instructions which, when executed by a computer, cause the computer to perform any one of methods in accordance with some exemplary embodiments of the present disclosure.

### BRIEF DESCRIPTION OF THE DRAWINGS

The above and other aspects and advantages of the present disclosure will become apparent from the following detailed description of exemplary embodiments taken in conjunction with the accompanying drawings which illustrate, by way of example, the principles of the present disclosure. Note that the drawings are not necessarily drawn to scale.

FIG. 1 illustrates an example wireless communication system, according to some embodiments;

FIG. 2 illustrates a base station (BS) in communication with a user equipment (UE) device, according to some embodiments;

FIG. 3 illustrates an example block diagram of a UE, according to some embodiments;

FIG. 4 illustrates an example block diagram of a BS, according to some embodiments;

FIG. 5 illustrates an example block diagram of cellular communication circuitry, according to some embodiments;

FIG. 6 illustrates an example flowchart diagram of an example method for a UE, according to some embodiments;

FIG. 7 illustrates an example flowchart diagram of an example method for a UE, according to some embodiments;

FIG. 8 illustrates an example flowchart diagram of an example method for a NW element, according to some embodiments;

FIG. 9 illustrates an example schematic diagram of an example channel having a first example subband full duplex (SB-FD) configuration, according to some embodiments;

FIG. 10 illustrates an example schematic diagram of an example channel having a second example SB-FD configuration, according to some embodiments;

FIG. 11 illustrates an example schematic diagram of a pair of adjacent example channels each having the first example SB-FD configuration, according to some embodiments;

FIG. 12 illustrates an example schematic diagram of a pair of adjacent example channels, one of which having the first example SB-FD configuration and another having a half duplex configuration, according to some embodiments; and

FIG. 13 illustrates an example schematic diagram of frequency resources of an example channel, according to some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION OF THE PREFERRED EMBODIMENTS

### Exemplary Terminology

For the purposes of the present document, the following terms and definitions are applicable to the examples and embodiments discussed herein, but are not meant to be limiting.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. The terms “application circuitry” and/or “baseband circuitry” may be considered synonymous to, and may be referred to as, “processor circuitry”.

The term “user equipment” (UE) (or “UE device”) as used herein refers to, is part of, or includes any of various types of computer systems or devices that are mobile or portable and that perform wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g. smart watch, smart glasses), PDAs, portable Internet devices, music players, data storage devices, or other handheld devices, etc. In general, the term “UE” or “UE device” can be broadly defined to encompass any electronic, computing, and/or telecommunications device (or combination of devices) which is easily transported by a user and capable of wireless communication.

The term “base station” has the full breadth of its ordinary meaning, and at least includes a wireless communication station installed at a fixed location and used to communicate as part of a wireless telephone system or radio system.

The term “network element” as used herein refers to physical or virtualized equipment and/or infrastructure used to provide wired or wireless communication network services. The term “network element” may be considered synonymous to and/or referred to as a network device, networked computer, networking hardware, network equipment, network node, router, switch, hub, bridge, radio network controller, RAN device, RAN node, gateway, server, virtualized VNF, NFVI, and/or the like. The term “base station” may be considered synonymous to, and may be referred to as, “network element”.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “channel” as used herein refers to a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 MHz wide. Other protocols and standards may include different definitions of channels. Furthermore, some standards may define and use multiple types of channels, e.g., different channels for uplink or downlink and/or different channels for different uses such as data, control information, etc.

The term “band” has the full breadth of its ordinary meaning, and at least includes a section of spectrum (e.g., radio frequency spectrum) in which channels are used or set aside for the same purpose.

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

The phrase “in various embodiments”, “in some embodiments”, and the like may refer to the same, or different, embodiments. The terms “comprising”, “having”, and “including” are synonymous, unless the context dictates otherwise. The phrase “A and/or B” means (A), (B), or (A and B). The phrases “A/B” and “A or B” mean (A), (B), or (A and B), similar to the phrase “A and/or B”. For the purposes of the present disclosure, the phrase “at least one of A and B” means (A), (B), or (A and B). The description may use the phrases “in an embodiment”, “in embodiments”, “in some embodiments”, and/or “in various embodiments”, which may each refer to one or more of the same or different embodiments. Furthermore, the terms “comprising”, “including”, “having”, and the like, as used with respect to embodiments of the present disclosure, are synonymous.

In the following detailed description, numerous specific details are set forth to provide a thorough understanding of the described exemplary embodiments. It will be apparent, however, to one skilled in the art that the described embodiments can be practiced without some or all of these specific details. In other exemplary embodiments, well known structures or process steps have not been described in detail in order to avoid unnecessarily obscuring the concept of the present disclosure.

### Communication System

FIG. 1 illustrates a simplified example wireless communication system, according to some embodiments. It is noted that the system of FIG. 1 is merely one example of a possible system, and that features of this disclosure may be implemented in any of various systems, as desired.

As shown, the example wireless communication system includes a base station 102A which communicates over a transmission medium with one or more user devices 106A, 106B, etc., through 106N. Each of the user devices may be referred to herein as a “user equipment” (UE). Thus, the user devices 106 are referred to as UEs or UE devices.

The base station (BS) 102A may be a base transceiver station (BTS) or cell site (a “cellular base station”), and may include hardware that enables wireless communication with the UEs 106A through 106N.

The communication area (or coverage area) of the base station may be referred to as a “cell”. The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1xRTT, 1xEV-DO, HRPD, eHRPD), etc. Note that if the base station 102A is implemented in the context of LTE, it may alternately be referred to as an ‘eNodeB’ or ‘eNB’. Note that if the base station 102A is implemented in the context of 5G NR, it may alternately be referred to as a ‘gNodeB’or ‘gNB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs. For example, it may be possible that that the base station 102A and one or more other base stations 102 support joint transmission, such that UE 106 may be able to receive transmissions from multiple base stations (and/or multiple TRPs provided by the same base station).

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1xRTT, 1xEV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H), and/or any other wireless communication protocol, if desired. Other combinations of wireless communication standards (including more than two wireless communication standards) are also possible.

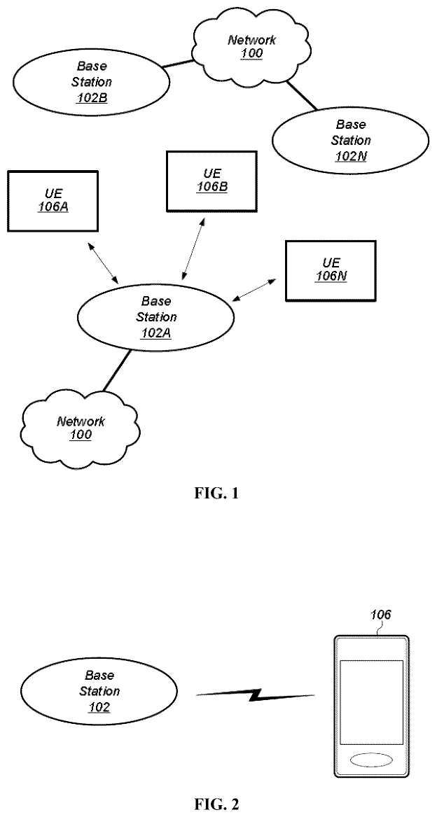

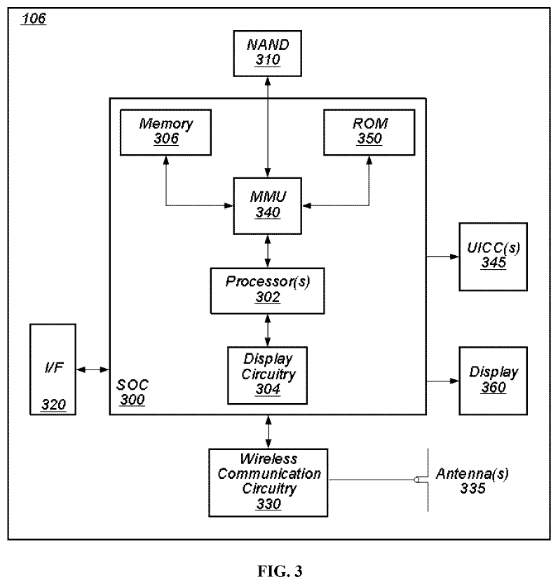

FIG. 2 illustrates user equipment 106 (e.g., one of the devices 106A through 106N) in communication with a base station 102, according to some embodiments. The UE 106 may be a device with cellular communication capability such as a mobile phone, a handheld device, a computer, a laptop, a tablet, a smart watch or other wearable device, or virtually any type of wireless device.

The UE 106 may include a processor (processing element) that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method embodiments described herein, or any portion of any of the method embodiments described herein.

The UE 106 may include one or more antennas for communicating using one or more wireless communication protocols or technologies. In some embodiments, the UE 106 may be configured to communicate using, for example, NR or LTE using at least some shared radio components. As additional possibilities, the UE 106 could be configured to communicate using CDMA2000 (1xRTT/1xEV-DO/HRPD/eHRPD) or LTE using a single shared radio and/or GSM or LTE using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or either of LTE or 1xRTT, or either of LTE or GSM, among various possibilities), and separate radios for communicating using each of Wi-Fi and Bluetooth. Other configurations are also possible.

### Block Diagram of a UE

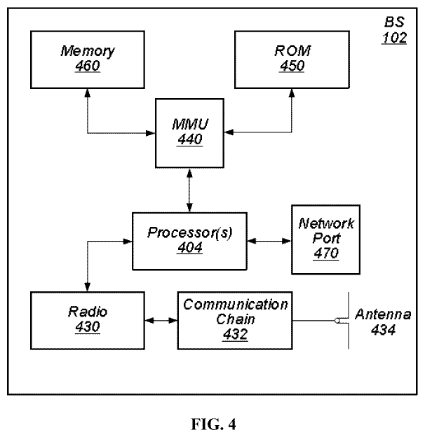

FIG. 3 illustrates an example simplified block diagram of a communication device 106, according to some embodiments. It is noted that the block diagram of the communication device of FIG. 3 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet, and/or a combination of devices, among other devices. As shown, the communication device 106 may include a set of components 300 configured to perform core functions. For example, this set of components may be implemented as a system on chip (SOC), which may include portions for various purposes. Alternatively, this set of components 300 may be implemented as separate components or groups of components for the various purposes. The set of components 300 may be coupled (e.g., communicatively; directly or indirectly) to various other circuits of the communication device 106.

For example, the communication device 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; etc.), the display 360, which may be integrated with or external to the communication device 106, and wireless communication circuitry 330 (e.g., for LTE, LTE-A, NR, UMTS, GSM, CDMA2000, Bluetooth, Wi-Fi, NFC, GPS, etc.). In some embodiments, communication device 106 may include wired communication circuitry (not shown), such as a network interface card, e.g., for Ethernet.

The wireless communication circuitry 330 may couple (e.g., communicatively; directly or indirectly) to one or more antennas, such as antenna(s) 335 as shown. The wireless communication circuitry 330 may include cellular communication circuitry and/or short to medium range wireless communication circuitry, and may include multiple receive chains and/or multiple transmit chains for receiving and/or transmitting multiple spatial streams, such as in a multiple-input multiple output (MIMO) configuration.

In some embodiments, as further described below, cellular communication circuitry 330 may include one or more receive chains (including and/or coupled to (e.g., communicatively; directly or indirectly) dedicated processors and/or radios) for multiple RATs (e.g., a first receive chain for LTE and a second receive chain for 5G NR). In addition, in some embodiments, cellular communication circuitry 330 may include a single transmit chain that may be switched between radios dedicated to specific RATs. For example, a first radio may be dedicated to a first RAT, e.g., LTE, and may be in communication with a dedicated receive chain and a transmit chain shared with a second radio. The second radio may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 360 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 345 that include SIM (Subscriber Identity Module) functionality, such as one or more UICC(s) (Universal Integrated Circuit Card(s)) cards 345.

As shown, the SOC 300 may include processor(s) 302, which may execute program instructions for the communication device 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, wireless communication circuitry 330, connector I/F 320, and/or display 360. The MMU 340 may be configured to perform memory protection and page table translation or set up. In some embodiments, the MMU 340 may be included as a portion of the processor(s) 302.

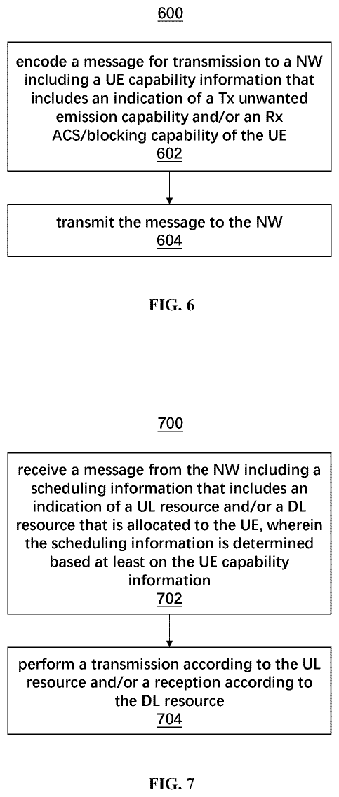

As noted above, the communication device 106 may be configured to communicate using wireless and/or wired communication circuitry. As described herein, the communication device 106 may include hardware and software components for implementing any of the various features and techniques described herein. The processor 302 of the communication device 106 may be configured to implement part or all of the features described herein, e.g., by executing program instructions stored on a memory medium (e.g., a non-transitory computer-readable memory medium). Alternatively (or in addition), processor 302 may be configured as a programmable hardware element, such as an FPGA (Field Programmable Gate Array), or as an ASIC (Application Specific Integrated Circuit). Alternatively (or in addition) the processor 302 of the communication device 106, in conjunction with one or more of the other components 300, 304, 306, 310, 320, 330, 340, 345, 350, 360 may be configured to implement part or all of the features described herein, including features described herein with respect to processes depicted in FIGS. 6 and 7.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, etc.) configured to perform the functions of processor(s) 302.

Further, as described herein, wireless communication circuitry 330 may include one or more processing elements. In other words, one or more processing elements may be included in wireless communication circuitry 330. Thus, wireless communication circuitry 330 may include one or more integrated circuits (ICs) that are configured to perform the functions of wireless communication circuitry 330. In addition, each integrated circuit may include circuitry (e.g., first circuitry, second circuitry, etc.) configured to perform the functions of wireless communication circuitry 330.

### Block Diagram of a Base Station

FIG. 4 illustrates an example block diagram of a base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 434, and possibly multiple antennas. The at least one antenna 434 may be configured to operate as a wireless transceiver and may be further configured to communicate with UE devices 106 via radio 430. The antenna 434 communicates with the radio 430 via communication chain 432. Communication chain 432 may be a receive chain, a transmit chain or both. The radio 430 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and LTE, 5G NR and Wi-Fi, LTE and Wi-Fi, LTE and UMTS, LTE and CDMA2000, UMTS and GSM, etc.).

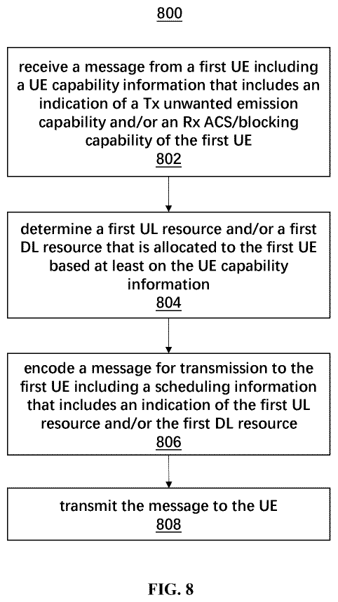

As described further subsequently herein, the BS 102 may include hardware and software components for implementing or supporting implementation of features described herein. The processor 404 of the base station 102 may be configured to implement or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. Alternatively (or in addition) the processor 404 of the BS 102, in conjunction with one or more of the other components 430, 432, 434, 440, 450, 460, 470 may be configured to implement or support implementation of part or all of the features described herein, including features described herein with respect to FIG. 8.

In addition, as described herein, processor(s) 404 may include one or more processing elements. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may include one or more processing elements. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

### Block Diagram of Cellular Communication Circuitry

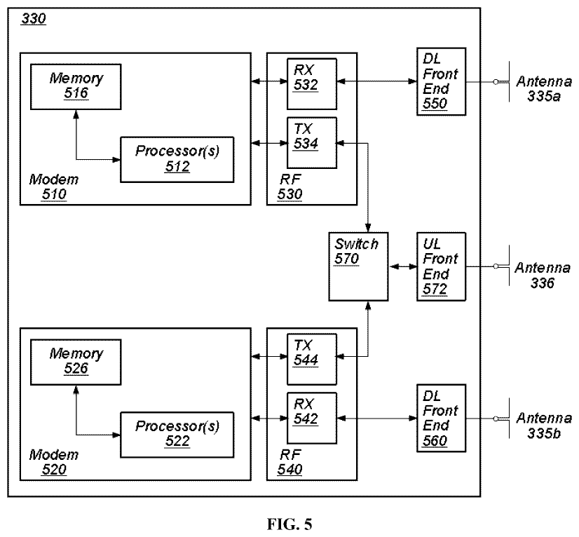

FIG. 5 illustrates an example simplified block diagram of cellular communication circuitry, according to some embodiments. It is noted that the block diagram of the cellular communication circuitry of FIG. 5 is only one example of a possible cellular communication circuit; other circuits, such as circuits including or coupled to sufficient antennas for different RATs to perform uplink activities using separate antennas, or circuits including or coupled to fewer antennas, e.g., that may be shared among multiple RATs, are also possible. According to some embodiments, cellular communication circuitry 330 may be included in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 330 may couple (e.g., communicatively; directly or indirectly) to one or more antennas, such as antennas 335a-b and 336 as shown. In some embodiments, cellular communication circuitry 330 may include dedicated receive chains (including and/or coupled to (e.g., communicatively; directly or indirectly) dedicated processors and/or radios) for multiple RATs (e.g., a first receive chain for LTE and a second receive chain for 5G NR). For example, as shown in FIG. 5, cellular communication circuitry 330 may include a first modem 510 and a second modem 520. The first modem 510 may be configured for communications according to a first RAT, e.g., such as LTE or LTE-A, and the second modem 520 may be configured for communications according to a second RAT, e.g., such as 5G NR.

As shown, the first modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, the second modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 330 receives instructions to transmit according to the first RAT (e.g., as supported via the first modem 510), switch 570 may be switched to a first state that allows the first modem 510 to transmit signals according to the first RAT (e.g., via a transmit chain that includes transmit circuitry 534 and UL front end 572). Similarly, when cellular communication circuitry 330 receives instructions to transmit according to the second RAT (e.g., as supported via the second modem 520), switch 570 may be switched to a second state that allows the second modem 520 to transmit signals according to the second RAT (e.g., via a transmit chain that includes transmit circuitry 544 and UL front end 572).

As described herein, the first modem 510 and/or the second modem 520 may include hardware and software components for implementing any of the various features and techniques described herein. The processors 512, 522 may be configured to implement part or all of the features described herein, e.g., by executing program instructions stored on a memory medium (e.g., a non-transitory computer-readable memory medium). Alternatively (or in addition), processors 512, 522 may be configured as a programmable hardware element, such as an FPGA (Field Programmable Gate Array), or as an ASIC (Application Specific Integrated Circuit). Alternatively (or in addition) the processors 512, 522, in conjunction with one or more of the other components 530, 532, 534, 540, 542, 544, 550, 570, 572, 335 and 336 may be configured to implement part or all of the features described herein.

In addition, as described herein, processors 512, 522 may include one or more processing elements. Thus, processors 512, 522 may include one or more integrated circuits (ICs) that are configured to perform the functions of processors 512, 522. In addition, each integrated circuit may include circuitry (e.g., first circuitry, second circuitry, etc.) configured to perform the functions of processors 512, 522.

In some embodiments, the cellular communication circuitry 330 may include only one transmit/receive chain. For example, the cellular communication circuitry 330 may not include the modem 520, the RF front end 540, the DL front end 560, and/or the antenna 335b. As another example, the cellular communication circuitry 330 may not include the modem 510, the RF front end 530, the DL front end 550, and/or the antenna 335a. In some embodiments, the cellular communication circuitry 330 may also not include the switch 570, and the RF front end 530 or the RF front end 540 may be in communication, e.g., directly, with the UL front end 572.

### Exemplary Frequency Resource

Among other things, embodiments described herein are directed to UE capabilities and duplex operations for new radio (NR) systems. Embodiments of the present disclosure may be utilized in conjunction with messages transmitted and/or received via radio resource control (RRC) signaling between a UE and an HW element (e.g., a BS).

According to embodiments of the present disclosure, UEs may report their UE capability information including co-channel Tx unwanted emission and/or Rx ACS/blocking capabilities, and/or an adjacent channel Tx unwanted emission and/or Rx ACS/blocking capabilities to an NW element (e.g., a BS). The BS may schedule these UEs, for example determine UL/DL resources for each UE, based on their UE capability information to implement duplex enhancement on the BS side, while UEs may operate in half duplex mode, for example, semi-static TDD or dynamic TDD.

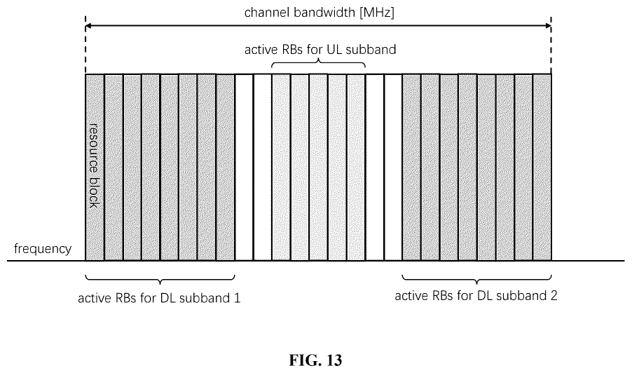

According to embodiments of the present disclosure, a BS may perform scheduling for those UEs operating in a single channel (“co-channel scheduling”), or one or more BSs may perform scheduling for those UEs operating in adjacent channels (“adjacent channel scheduling”). FIG. 13 illustrates an example schematic diagram of frequency resources of an example channel. The example channel may include a section of frequency band. The bandwidth of the channel is not limited in the present disclosure. For example, the channel bandwidth may be 100 MHz for frequency range (FR)1 and 400 MHz for FR2. The channel may include multiple resource blocks (RBs). The BS may configure some RBs used for DL resources and some RBs used for UL resources. In FIG. 13, a plurality of consecutive first RBs are configured for a first DL resource, referred to as “DL subband 1”, a plurality of consecutive second RBs are configured for a second DL resource, referred to as “DL subband 2”, and a plurality of consecutive third RBs are configured for a UL resource, referred to as “UL subband”. In the illustrated example, the UL subband is configured between the DL subband 1 and DL subband 2 in the frequency domain, with a guard band on each side thereof to reduce cross link interference. It will be appreciated that there may be a guard band on each side of the channel although not shown.

### Exemplary Operations for a Ue

FIG. 6 is a flowchart diagram illustrating an example method 600 for a UE, according to some embodiments. Aspects of the method 600 may be implemented by a wireless device such as a UE 106 illustrated in various of the Figures herein and/or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements.

In various embodiments, some of the elements of the methods shown may be performed concurrently, in a different order than shown, may be substituted for by other method elements, or may be omitted. Additional elements may also be performed as desired. As shown, the method 600 may operate as follows.

At 602, a wireless device (also referred to as “UE” hereinafter for simplicity) may encode a message for transmission to a NW including a UE capability information that includes an indication of a transmitting (Tx) unwanted emission capability and/or a receiving (Rx) ACS/blocking capability of the UE. At 604, the wireless device may transmit the message to the NW. The NW may perform duplex-related scheduling based on the UE capability information that includes an indication of a Tx unwanted emission capability and/or an Rx ACS/blocking capability of the UE.

Both Tx unwanted emission capability and Rx ACS/blocking capability are capabilities of a UE associated with frequency spectrum. For Tx, when a UE is transmitting in a band, there may be out-of-band emissions due to inefficiencies or defects of the transmitter of the UE. For example, when a UE is transmitting in a channel, there may be an emission leaking into another channel (for example an adjacent channel, referred to as an “adjacent channel leakage” in this case); or when a UE is transmitting in a subband within a channel, there may be an emission leaking into another subband within the channel (“co-channel inter-subband leakage” or “co-channel leakage”). Such a leakage may subject a BS or another UE operating in the another channel or the another subband to interference. A Tx unwanted emission capability of a UE may reflect a level of the out-of-band emissions by the UE.

The Tx unwanted emission capability of a UE is dependent on both radio frequency (RF) and base band (BB) performance of the UE. For example, depending on if PA technologies such as envelope tracking (ET) are used or not, some UEs will have a better Tx unwanted emission capability and some will not. Therefore, information of Tx unwanted emission capabilities of UEs will help a NW schedule in order to mitigate interference caused by Tx of UEs.

According to some embodiments, the indication of the Tx unwanted emission capability may include an indicator that indicates whether a Tx unwanted emission level of the UE is lower than a specified Tx unwanted emission level. The Tx unwanted emission level may reflect a Tx capability of the UE to limit unwanted emission at the adjacent channel or subband, given its transmission within the intended channel or subband, usually characterized by performance requirements such as Spectrum Emission Mask and/or Adjacent Channel Leakage power Ratio (ACLR) in 3GPP. ACLR is the ratio of the filtered mean power centred on the assigned channel frequency to the filtered mean power centred on an adjacent channel frequency. Given the UE transmission power, if the out-of-band leakage is lower, namely ACLR is higher, the Tx unwanted emission capability of the UE is better. A 3GPP specification may specify an indicator that may indicate a UE's unwanted emission capability. For example, the indicator may include an enumerated variable, such as {normal, better} or {worse, better}, to indicate whether a better than normal Tx unwanted emission capability is supported by the UE.

According to some embodiments, the indication of the Tx unwanted emission capability may include an indicator that indicates a Tx unwanted emission level of the UE in dB value. In these embodiments, the Tx unwanted emission capability may be represented by an adjacent channel leakage ratio (ACLR) with respect to an adjacent channel, or an ACLR with respect to an adjacent subband, in a similar manner of ACLR defined in a 3GPP specification, such as {24, 26, 28, 30, 32, 34, 36 . . . }. It will be noted that the listed values are example values of the indicator, and other suitable values may be specified in the specification.

According to some embodiments, the indication of the Tx unwanted emission capability may include a first indicator that indicates a co-channel Tx unwanted emission level of the UE and/or a second indicator that indicates an adjacent channel Tx unwanted emission level of the UE. Based on the above, the out-of-band emissions may include co-channel leakage and adjacent channel leakage. Accordingly, the co-channel Tx unwanted emission level may reflect a Tx capability of the UE to limit unwanted emission at the adjacent subband, given its transmission within the intended subband, with both subbands located in the same channel, for example expressed as a ratio of a Tx power of the UE within the intended subband of the channel to an emission power at the adjacent subband within the same channel. The adjacent channel Tx unwanted emission level may reflect a Tx capability of the UE to limit unwanted emission at the adjacent channel(s), given its transmission within the intended channel, for example expressed as a ratio of a Tx power of the UE within the intended channel to an emission power at the adjacent channel(s). The first indicator to indicate the co-channel Tx unwanted emission level and/or the second indicator to indicate the adjacent channel Tx unwanted emission level may be included in the indication of the Tx unwanted emission capability to be reported to the NW. Either the first or second indicator may: 1) indicate whether the co-channel/adjacent channel Tx unwanted emission level is lower than a specified level; or 2) indicate a co-channel/adjacent channel Tx unwanted emission level in dB value.

For Rx, when a UE is receiving in an intended channel or subband, the interference within another channel (usually an adjacent channel) or another subband may impact the receiving of the UE, since the receiver of the UE is not perfect. An Rx ACS/blocking capability may reflect a capability of the receiver of the UE to block out-of-band interference. The term “Rx ACS/blocking capability” with the character “/” means an Rx ACS capability or an Rx blocking capability. The UE capability information may include an indication of the Rx ACS capability or the Rx blocking capability. The Rx ACS/blocking capability may depend on multiple factors. In adjacent channel receiving case (that is, receiving in an intended channel), different UEs may have different adjacent channel ACS/blocking capabilities due to different BB filtering (both digital and analog), phase noises, Rx non-linearities (second-order or third-order), etc. In co-channel receiving case (that is, receiving in an intended subband of a channel), some UEs may have subband specific filtering while others may not, and thus UEs may have different co-channel Rx ACS/blocking capabilities. It will be appreciated that it does not mean a UE has to implement subband filtering with RB granularity. A UE may have the capability of subband filtering with RB granularity or not. The NW will implement a subband full duplex related scheduling based on the capabilities of UEs.

According to some embodiments, the indication of the Rx ACS/blocking capability may include an indicator that indicates whether an Rx ACS/blocking level of the UE is higher than a specified Rx ACS/blocking level. If the Rx ACS/blocking level is higher, the Rx ACS/blocking capability of the UE is better. A 3GPP specification may specify a certain Rx ACS/blocking level, the indicator may indicate whether the Rx ACS/blocking level of the UE is higher than the specified Rx ACS/blocking level. For example, the indicator may include an enumerated variable, such as {normal, better} or {worse, better} , to indicate whether a higher Rx ACS/blocking level is supported by the UE.

According to some embodiments, the indication of the Rx ACS/blocking capability may include an indicator that indicates an Rx ACS/blocking level of the UE in dB value. In these embodiments, the indicator may include an integer variable, such as {30, 32, 34 . . . }, to indicate the Rx ACS/blocking level in dB value. It will be noted that the listed values are example values of the indicator, and other suitable values may be specified in the specification.

According to some embodiments, the indication of the Rx ACS/blocking capability may include a first indicator that indicates a co-channel Rx ACS/blocking level of the UE and/or a second indicator that indicates an adjacent channel Rx ACS/blocking level of the UE. The co-channel Rx ACS/blocking level may reflect a capability of the UE to block unwanted signal(s) within other subband(s) of a channel except the intended subband of the same channel where a desired signal is. The adjacent channel Rx ACS/blocking level may reflect a capability of the UE to block unwanted signal(s) within adjacent channel(s) of the intended channel where a desired signal is. The first indicator to indicate the co-channel Rx ACS/blocking level and/or the second indicator to indicate the adjacent channel Rx ACS/blocking level may be included in the indication of the Rx ACS/blocking capability to be reported to the NW. Either the first or second indicator may: 1) indicate whether the co-channel/adjacent channel Rx ACS/blocking level is higher than a specified level; or 2) indicate a co-channel/adjacent channel Rx ACS/blocking level in dB value.

According to some embodiments, the indication of the Rx ACS/blocking capability includes an indicator that indicates a minimum frequency offset for reception of the UE. The UE supported minimum frequency offset (or “guard band”) for reception, between intended channel and interfering channel or between intended subband and interfering subband, may be presented in the bandwidth of the guard band in Hz or in number of RBs. The NW may schedule, based on the UE capability information including the Rx ACS/blocking capability, the UE receiving in a first band and another UE transmitting at the same time in a second band, wherein the spacing from the second band to the first band is larger than the guard band.

According to some embodiments, the UE capability information mentioned above may be specified for the UE or for each frequency range (FR) or for each frequency band that is supported by the UE. The UE may support a first Tx unwanted emission capability and/or a first Rx ACS/blocking capability when working in FR1 (for example, the frequency range from 410 MHz to 7125 MHz) and support a second Tx unwanted emission capability and/or a second Rx ACS/blocking capability when working in FR2 (for example, the frequency range from 24250 MHz to 52600 MHZ). Therefore, the UE capability information may be specified for each FR. Similarly, the UE capability information may be specified for each bandwidth part (BWP), each band or band-combination. However, the Tx unwanted emission capability and/or the Rx ACS/blocking capability may not vary significantly with frequency. In this case, The UE capability information may be specified for the UE, regardless of the frequency, the FR, the BWP, the band or band-combination, for example.

In above embodiments, the Tx unwanted emission capability and the Rx ACS/blocking capability are reported separately. In order to simplify the implementation of a UE, according to some embodiments, the UE capability information may include an indication that indicates both the Tx unwanted emission capability and the Rx ACS/blocking capability of the UE.

FIG. 7 is a flowchart diagram illustrating an example method 700 for a UE, according to some embodiments. Aspects of the method 700 may be implemented by a wireless device such as a UE 106 illustrated in various of the Figures herein and/or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements.

In various embodiments, some of the elements of the methods shown may be performed concurrently, in a different order than shown, may be substituted for by other method elements, or may be omitted. Additional elements may also be performed as desired. As shown, the method 700 may operate as follows.

At 702, a wireless device (also referred to as “UE” hereinafter for simplicity) may receive a message from the NW including a scheduling information that includes an indication of an uplink (UL) resource and/or a downlink (DL) resource that is allocated to the UE, wherein the scheduling information is determined based at least on the UE capability information described above. At 704, the wireless device may perform a transmission according to the UL resource and/or a reception according to the DL resource. Either UL resource or DL resource may include a time resource and/or a frequency resource.

### Exemplary Operations for a NW Element

FIG. 8 is a flowchart diagram illustrating an example method 800 for a NW element, according to some embodiments. Aspects of the method 800 may be implemented by a base station such as a BS 102 illustrated in various of the Figures herein and/or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements.

In various embodiments, some of the elements of the methods shown may be performed concurrently, in a different order than shown, may be substituted for by other method elements, or may be omitted. Additional elements may also be performed as desired. As shown, the method 800 may operate as follows.

At 802, a wireless device (also referred to as “NW” hereinafter for simplicity) may receive a message from a first user equipment (UE) including a UE capability information that includes an indication of a transmitting (Tx) unwanted emission capability and/or a receiving (Rx) ACS/blocking capability of the first UE. At 804, the wireless device may determine a first uplink (UL) resource and/or a first downlink (DL) resource that is allocated to the first UE based at least on the UE capability information. At 806, the wireless device may encode a message for transmission to the first UE including a scheduling information that includes an indication of the first UL resource and/or the first DL resource. At 808, the wireless device may transmit the message to the UE.

The determining the first UL resource and the first DL resource that is allocated to the first UE is a part of NW scheduling. Actually, the NW may schedule resources (substantively relates to frequency resources, for example RBs or subbands, in the present disclosure) within one or more channels that are operated by the NW for multiple UEs operating in the one or more channels, based on UE capability information of all these UEs.

According to some embodiments, the NW element is configured to schedule resources within a first channel that includes at least a UL subband and a DL subband that is adjacent to the UL subband. The NW element may: in response to the UE capability information indicating a better Tx unwanted emission capability, determine the UL subband as the first UL resource and the DL subband being allocated to a second UE having either a better Rx ACS/blocking capability or a worse Rx ACS/blocking capability; in response to the UE capability information indicating a worse Tx unwanted emission capability, determine the UL subband as the first UL resource and the DL subband being allocated to a third UE having a better Rx ACS/blocking capability; in response to the UE capability information indicating a better Rx ACS/blocking capability, determine the DL subband as the first DL resource and the UL subband being allocated to a fourth UE having either a better Tx unwanted emission capability or a worse Tx unwanted emission capability; or in response to the UE capability information indicating a worse Rx ACS/blocking capability, determine the DL subband as the first DL resource and the UL subband being allocated to a fifth UE having a better Tx unwanted emission capability. Although not described explicitly in this paragraph, it will be appreciated that determining the DL/UL subband being allocated to another UE (the second through fifth UE) means the DL/UL subband being allocated to the another UE at the same time as the adjacent UL/DL subband being allocated to the first UE, for example, in a single time slot.

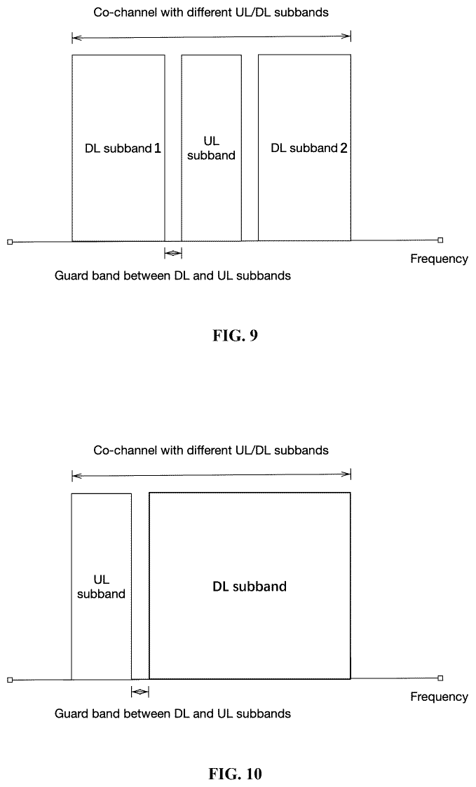

It can be seen that these embodiments relate to co-channel scheduling. A first example case of co-channel scheduling will be described with reference to FIG. 9, which illustrates an example schematic diagram of an example channel having a first example subband full duplex (SB-FD) configuration. The channel includes two DL subband (DL subband 1 and DL subband 2) and a UL subband. UE1 through UE4 are operating in the channel shown in FIG. 9. UE1 has a better Tx unwanted emission capability, i.e., leaking less Tx interference into adjacent DL subband; UE2 has a worse Tx unwanted emission capability, i.e., leaking more Tx interference into adjacent DL subband; UE3 has a better Rx ACS/blocking capability, i.e., being able to handle more interference in adjacent UL subband; and UE4 has a worse Rx ACS/blocking capability, i.e., being able to handle less interference in adjacent UL subband. UE1 and UE2 are being considered for Tx on the UL subband, and UE3 and UE4 are being considered for Rx on the DL subband.

After receiving UE capability information of UE1 through UE4, the NW may perform scheduling based on the UE capability information. For example, the NW may schedule UE1 and UE3 at the same time (for example in the same time slot), that is, allocate the UL subband to UE1 and allocate DL subband 1 and/or DL subband 2 to UE3. Since UE1 has a better Tx unwanted emission capability and UE3 has a better Rx ACS/blocking capability, a best performance (least inter-subband interference) will be achieved in this example scheduling configuration. For other examples, the NW may schedule UE1 and UE4 at the same time, that is, allocate the UL subband to UE1 and allocate DL subband 1 and/or DL subband 2 to UE4; or schedule UE2 and UE3 at the same time, that is, allocate the UL subband to UE2 and allocate DL subband 1 and/or DL subband 2 to UE3. Since UE1 has a better Tx unwanted emission capability although UE4 has a worse Rx ACS/blocking capability, or UE3 has a better Rx ACS/blocking capability although UE2 has a worse Tx unwanted emission capability, a better performance (not the best, but acceptable) will be achieved in these example scheduling configurations. For further example, the NW may avoid scheduling UE2 and UE4 at the same time, since both of them have worse capabilities.

A second example case of co-channel scheduling will be described with reference to FIG. 10, which illustrates an example schematic diagram of an example channel having a second example SB-FD configuration. The channel includes a DL subband and a UL subband. UE1 through UE4 are operating in the channel shown in FIG. 10. UE1 has a better Tx unwanted emission capability, i.e., leaking less Tx interference into adjacent DL subband; UE2 has a worse Tx unwanted emission capability, i.e., leaking more Tx interference into adjacent DL subband; UE3 has a better Rx ACS/blocking capability, i.e., being able to handle more interference in adjacent UL subband; and UE4 has a worse Rx ACS/blocking capability, i.e., being able to handle less interference in adjacent UL subband. UE1 and UE2 are being considered for Tx on the UL subband, and UE3 and UE4 are being considered for Rx on the DL subband.

After receiving UE capability information of UE1 through UE4, the NW may perform scheduling base on the UE capability information. For example, the NW may schedule UE1 and UE3 at the same time, that is, allocate the UL subband to UE1 and allocate the DL subband to UE3; schedule UE1 and UE4 at the same time, that is, allocate the UL subband to UE1 and allocate the DL subband to UE4; or schedule UE2 and UE3 at the same time, that is, allocate the UL subband to UE2 and allocate the DL subband to UE3. Similarly, the NW may avoid scheduling UE2 and UE 4 at the same time, since both of them have worse capabilities.

According to some embodiments, the NW element may determine the first UL resource and/or the first DL resource being allocated to the first UE based further on a Tx power of the first UE, a channel quality of the first UE, or a relative location between the first UE and another UE. Since the actual interference level (for example, the Tx power minus the Tx unwanted emission capability in terms of ACLR) from a Tx UE depends on the Tx power of the UE, the Tx power of the UE may be considered during scheduling. If a UE is relatively close to the BS, the Tx power will not be very high. In this case, the interference will not be large anyway. And thus, even if the Tx unwanted emission capability of the UE is not good, it may be scheduled to Tx in the UL subband at the same time as another UE performing Rx in either DL subband. If the channel quality is good (for example, determined from a reported channel quality indicator (CQI)), even if some interference is nearby, a UE may receive signals normally. In other words, even if the Rx ACS/blocking capability of the UE is not relatively high, it may be scheduled to Rx in either DL subband while another UE is performing Tx in the UL subband. In this case, the UE may not be suitable for a higher-order modulation scheme (for example, 256 QAM or 64 QAM), and the NW may consider configuring a lower-order modulation scheme (for example 16 QAM or even QPSK) for the UE. A relative location (meaning the geographical location), or a distance, between a Tx UE and an Rx UE may also be considered during scheduling. For example, if UE2 and UE4 are far from each other, they may be scheduled to Tx/Rx at the same time even if their Tx/Rx capability is poor, since it may be difficult for the interference from UE2 to affect the distant UE4.

According to some embodiments, the NW element is configured to schedule resources within both a first channel and a second channel that is adjacent to the first channel. The NW element may: in response to the UE capability information indicating a better Tx unwanted emission capability, determine the UL subband as the first UL resource and a DL resource of the second channel being allocated to a six UE having either a better Rx ACS/blocking capability or a worse Rx ACS/blocking capability; in response to the UE capability information indicating a worse Tx unwanted emission capability, determine the UL subband as the first UL resource and the DL resource of the second channel being allocated to a seven UE having a better Rx ACS/blocking capability; in response to the UE capability information indicating a better Rx ACS/blocking capability, determine the DL subband as the first DL resource and a UL resource of the second channel being allocated to an eighth UE having either a better Tx unwanted emission capability or a worse Tx unwanted emission capability; or in response to the UE capability information indicating a worse Rx ACS/blocking capability, determine the DL subband as the first DL resource and the UL resource of the second channel being allocated to a ninth UE having a better Tx unwanted emission capability. Although not described explicitly in the this paragraph, it will be appreciated that determining the DL/UL subband being allocated to another UE (the sixth through ninth UE) means the DL/UL subband being allocated to the another UE at the same time as the adjacent UL/DL subband being allocated to the first UE, for example, in a single time slot.

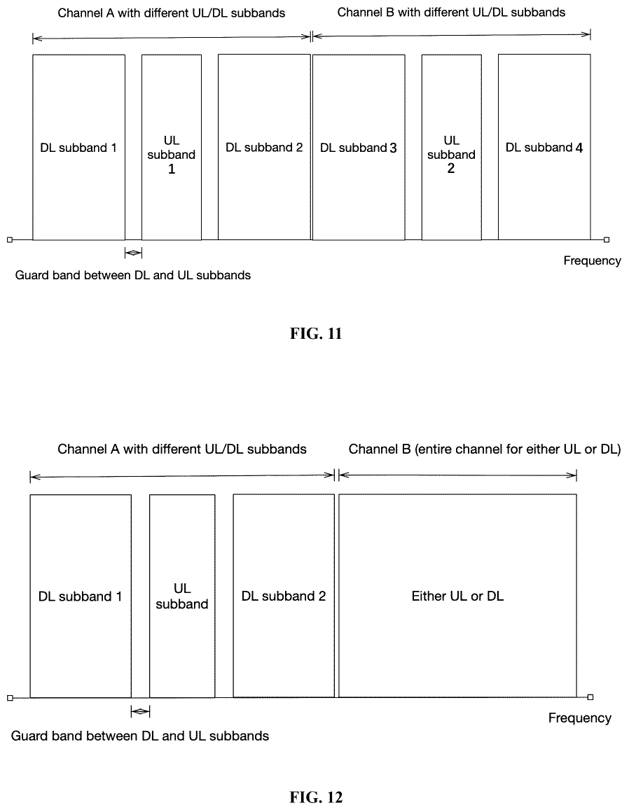

It can be seen that these embodiments relate to adjacent channel scheduling, and the adjacent channels are operated by a single NW element. A first example case of adjacent channel scheduling will be described with reference to FIG. 11, which illustrates an example schematic diagram of a pair of adjacent example channels each having the first example SB-FD configuration. The first channel, “channel A”, includes two DL subband (DL subband 1 and DL subband 2) and a UL subband (UL subband 1). The second channel, “channel B”, includes two DL subband (DL subband 3 and DL subband 4) and a UL subband (UL subband 2). UE1 and UE2 are operating in channel A, and UE3 and UE4 are operating in channel B. UE1 has a better Tx unwanted emission capability, i.e., leaking less Tx interference into adjacent channel; UE2 has a worse Tx unwanted emission capability, i.e., leaking more Tx interference into adjacent channel; UE3 has a better Rx ACS/blocking capability, i.e., being able to handle more interference in adjacent channel; and UE4 has a worse Rx ACS/blocking capability, i.e., being able to handle less interference in adjacent channel. UE1 and UE2 are being considered for Tx on UL subband 1 of channel A, and UE3 and UE4 are being considered for Rx on DL subband 3 and/or DL subband 4 of channel B.

After receiving UE capability information of UE1 through UE4, the NW may perform scheduling base on the UE capability information. For example, the NW may allocate UL subband 1 to UE1, and allocate either DL subband 3 or 4, or both of DL subbands 3 and 4 to UE3. Since UE1 has a better Tx unwanted emission capability and UE3 has a better Rx ACS/blocking capability, although DL subband 3 is not far from UL subband 1, allocating DL subband 3 to UE3 while allocating UL subband 1 to UE1 may achieve a good performance. For a further example, the NW may allocate UL subband 1 to UE1 and allocate either DL subband 3 or 4, or both of DL subbands 3 and 4 to UE4; or allocate UL subband 1 to UE2 and allocate either DL subband 3 or 4, or both of DL subbands 3 and 4 to UE3. Since UE1 has a better Tx unwanted emission capability although UE4 has a worse Rx ACS/blocking capability, or UE3 has a better Rx ACS/blocking capability although UE2 has a worse Tx unwanted emission capability, an acceptable performance will be achieved. For further example, the NW may allocate UL subband 1 to UE2 and only allocate DL subband 4 (the DL subband farther from channel A) to UE4. Since UE2 has a worse Tx unwanted emission capability and UE4 has a worse Rx ACS/blocking capability, the NW may avoid allocating DL subband 3 (the DL subband closer to channel A) to UE4.

A second example case of adjacent channel scheduling will be described with reference to FIG. 12, which illustrates an example schematic diagram of a pair of adjacent example channels, one of which having the first example SB-FD configuration and another having a half duplex configuration, according to some embodiments. The first channel, “channel A”, includes two DL subband (DL subband 1 and DL subband 2) and a UL subband. The second channel, “channel B”, operates in a half duplex mode (for example a TDD mode), may be a UL channel or a DL channel at a certain time. UE1 through UE4 are operating in channel A. UE1 has a better Tx unwanted emission capability, i.e., leaking less Tx interference into adjacent channel; UE2 has a worse Tx unwanted emission capability, i.e., leaking more Tx interference into adjacent channel; UE3 has a better Rx ACS/blocking capability, i.e., being able to handle more interference in adjacent channel; and UE4 has a worse Rx ACS/blocking capability, i.e., being able to handle less interference in adjacent channel. UE1 and UE2 are being considered for Tx on the UL subband of channel A, and UE3 and UE4 are being considered for Rx on the DL subbands of channel A.

After receiving UE capability information of UE1 through UE4, the NW may perform scheduling base on the UE capability information. For example, the NW may schedule UE1 when channel B is transmitting in the DL, schedule UE1 or UE2 when channel is transmitting in the UL, schedule UE 3 or UE 4 when channel B is transmitting in the DL, schedule UE3 on either DL subband 1 or 2 when channel B is transmitting in the UL, or schedule UE3 on DL subband 2 (the DL subband closer to channel B) and UE4 on DL subband 1 (the DL subband farther from channel B) when channel B is transmitting in the UL. For channel B scheduling, the NW may configure channel B with consideration of the scheduling scheme of channel A. For example, the NW may schedule channel B regardless of the scheduling of UE1 and UE3 which have better capability, but with taking account of UE2 and UE4. For example, when UE2 is scheduled and UE4 is not scheduled in DL subband 2, configure channel B for UL transmitting; when UE4 is scheduled in DL subband 2, configure channel B for DL transmitting. As for the scheduling in channel A that UE2 is scheduled in the UL subband and UE4 is scheduled in DL subband 2, it is suggested to be avoid in above paragraphs describing co-channel scheduling.

According to some embodiments, similar to the co-channel scheduling, the NW element may also consider a Tx power of a Tx UE, a channel quality of a Rx UE, or a relative location between a Tx UE and a Rx UE for adjacent channel scheduling.

According to some embodiments, a second channel that is adjacent to the first channel is operated by another NW element, the NW element may acquire a configuration information of the second channel from another NW element. The NW element may: in response to the UE capability information indicating a better Tx unwanted emission capability and the configuration information indicating a DL resource of the second channel being allocated to a six UE having either a better Rx ACS/blocking capability or a worse Rx ACS/blocking capability, determining the UL subband as the first UL resource; in response to the UE capability information indicating a worse Tx unwanted emission capability and the configuration information indicating the DL resource of the second channel being allocated to a seven UE having a better Rx ACS/blocking capability, determining the UL subband as the first UL resource; in response to the UE capability information indicating a better Rx ACS/blocking capability and the configuration information indicating a UL resource of the second channel being allocated to an eighth UE having either a better Tx unwanted emission capability or a worse Tx unwanted emission capability, determining the DL subband as the first DL resource; or in response to the UE capability information indicating a worse Rx ACS/blocking capability and the configuration information indicating the UL resource of the second channel being allocated to a ninth UE having a better Tx unwanted emission capability, determining the DL subband as the first DL resource.

It can be seen that these embodiments relate to adjacent channel scheduling, and the adjacent channels are operated by two separate NW elements, for example, two separate BSs. Each NW element schedules the UEs operating in the corresponding channel. The considerations during scheduling in this circumstance are similar to that described above with reference to FIGS. 11 and 12, that is, the adjacent channels operated by a single NW element, and thus, duplicate descriptions are omitted here.

According to some embodiments, the NW element (for example operating the first channel, referred to as the “first BS” for simplicity) may acquire the configuration information of the second channel from the another NW element (for example operating the second channel, referred to as the “second BS” for simplicity) via information exchange between the first BS and the second BS. For example, there may be a coordination or information exchange between the first BS and the second BS, especially when the two BSs belong to the same operator. The BSs may communicate therebetween via a backhaul, which has a relatively small delay and allows the BSs to perform joint scheduling on a small time scale, for example, a TTI level joint scheduling. If there is no small delay communication between the two BSs, a long-term joint scheduling may be performed.

If the BSs belong to different operators, and no coordination/information exchange between operators can be achieved, the first BS may acquire the configuration information of the second channel from the second BS via at least one of:
1) a receiver that is operated to decode a system information block (SIB) from the second BS. A subband configuration and/or TDD UL/DL configuration may be broadcasted in a SIB of the second BS. The first BS may have an additional UE-like receiver capable of operating in the second channel. The first BS may use this receiver to decode the SIB of the second BS to learn subband configuration and/or TDD UL/DL configuration of the second channel. The subband configuration may include which DL/UL subbands are included in the channel, and the frequency range of each subband. The TDD UL/DL configuration provides the TDD UL-DL pattern, i.e., info for UE to know when to transmit and when to receive in a slot/symbol.
2) a UE operating in the first channel that is operated to measure the second channel. The first BS may trigger a UE on its cell to perform a cell global identifier (CGI) reading with subband configuration acquisition and/or TDD UL/DL configuration on the cell of the second BS, for example, like a self-organizing NW (SON) function. For example, the first BS may configure one or more UEs to measure the cell of the second BS and to report subband configuration (such configuration is broadcast in cell system information of the second BS) and/or TDD UL/DL configuration of the second channel.

With the above approaches, the first BS may learn the subband configuration and/or TDD UL/DL configuration of the second channel. Although the scheme of allocating each subband of the second channel to which UE(s) cannot be known by the firs BS and thus joint scheduling with the second BS cannot be performed, the subband configuration and/or TDD UL/DL configuration of the second channel is useful for the first BS to optimize its own scheduling.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Those skilled in the art may clearly know from the above embodiments that the present disclosure may be implemented by software with necessary hardware, or by hardware, firmware and the like. Based on such understanding, the embodiments of the present disclosure may be embodied in part in a software form. The computer software may be stored in a readable storage medium such as a floppy disk, a hard disk, an optical disk or a flash memory of the computer. The computer software comprises a series of instructions to make the computer (e.g., a personal computer, a service station or a network terminal) execute the method or a part thereof according to respective embodiment of the present disclosure.

The present disclosure being thus described, it will be obvious that the same may be varied in many ways. Such variations are not to be regarded as a departure from the spirit and scope of the present disclosure, and all such modifications as would be obvious to those skilled in the art are intended to be included within the scope of the following claims.

1. An apparatus, comprising:
a memory configured to store instructions;
processor circuitry coupled to the memory, and when executing the instructions, configured to:
encode for transmission to a network (NW) a UE capability information that includes an indication of a transmitting (Tx) unwanted emission capability and/or a receiving (Rx) adjacent channel selectivity (ACS)/blocking capability of a user equipment (UE);
receive, from the NW, a scheduling information that includes an indication of an uplink (UL) resource and/or a downlink (DL) resource that is allocated to the UE; and
communicate with the NW using the UL resource and/or the DL resource,
wherein the scheduling information is determined based on the UE capability information.

2. The apparatus according to claim 1, wherein the indication of the Tx unwanted emission capability includes an indicator that indicates whether a Tx unwanted emission level of the UE is lower than a specified Tx unwanted emission level.

3. The apparatus according to claim 1, wherein the indication of the Tx unwanted emission capability includes an indicator that indicates a Tx unwanted emission level of the UE in dB value.

4. The apparatus according to claim 1, wherein the indication of the Tx unwanted emission capability includes a first indicator that indicates a co-channel Tx unwanted emission level of the UE and/or a second indicator that indicates an adjacent channel Tx unwanted emission level of the UE.

5. The apparatus according to claim 1, wherein the indication of the Rx ACS/blocking capability includes an indicator that indicates whether an Rx ACS/blocking level of the UE is higher than a specified Rx ACS/blocking level.

6. The apparatus according to claim 1, wherein the indication of the Rx ACS/blocking capability includes an indicator that indicates an Rx ACS/blocking level of the UE in dB value.

7. The apparatus according to claim 1, wherein the indication of the Rx ACS/blocking capability includes a first indicator that indicates a co-channel Rx ACS/blocking level of the UE and/or a second indicator that indicates an adjacent channel Rx ACS/blocking level of the UE.

8. The apparatus according to claim 1, wherein the indication of the Rx ACS/blocking capability includes an indicator that indicates a minimum frequency offset for reception of the UE.

9. The apparatus according to claim 1, wherein the UE capability information is specified for:
the UE;
each frequency range that is supported by the UE; or
each frequency band that is supported by the UE.

10. A method for a user equipment (UE), comprising:
transmitting, to a network (NW), a UE capability information that includes an indication of a transmitting (Tx) unwanted emission capability and/or a receiving (Rx) adjacent channel selectivity (ACS)/blocking capability of the UE;
receiving, from the NW, a scheduling information that includes an indication of an uplink (UL) resource and/or a downlink (DL) resource that is allocated to the UE; and
communicating with the NW using the UL resource and/or the DL resource,
wherein the scheduling information is determined based on the UE capability information.

11. The method according to claim 10, wherein the indication of the Tx unwanted emission capability includes an indicator that indicates whether a Tx unwanted emission level of the UE is lower than a specified Tx unwanted emission level.

12. The method according to claim 10, wherein the indication of the Tx unwanted emission capability includes an indicator that indicates a Tx unwanted emission level of the UE in dB value.

13. The method according to claim 10, wherein the indication of the Tx unwanted emission capability includes a first indicator that indicates a co-channel Tx unwanted emission level of the UE and/or a second indicator that indicates an adjacent channel Tx unwanted emission level of the UE.

14. The method according to claim 10, wherein the indication of the Rx ACS/blocking capability includes an indicator that indicates whether an Rx ACS/blocking level of the UE is higher than a specified Rx ACS/blocking level.

15. The method according to claim 10, wherein the indication of the Rx ACS/blocking capability includes an indicator that indicates an Rx ACS/blocking level of the UE in dB value.

16. The method according to claim 10, wherein the indication of the Rx ACS/blocking capability includes a first indicator that indicates a co-channel Rx ACS/blocking level of the UE and/or a second indicator that indicates an adjacent channel Rx ACS/blocking level of the UE.

17. The method according to claim 10, wherein the indication of the Rx ACS/blocking capability includes an indicator that indicates a minimum frequency offset for reception of the UE.

18. The method according to claim 10, wherein the UE capability information is specified for:
the UE;
each frequency range that is supported by the UE; or
each frequency band that is supported by the UE.

19. (canceled)

20. A method for a network (NW) element, the method comprising:
receiving a message from a first user equipment (UE) including a UE capability information that includes an indication of a transmitting (Tx) unwanted emission capability and/or a receiving (Rx) adjacent channel selectivity (ACS)/blocking capability of the first UE;
determining a first uplink (UL) resource and/or a first downlink (DL) resource that is allocated to the first UE based on the UE capability information;
transmitting to the first UE scheduling information that includes an indication of the first UL resource and/or the first DL resource.

21. The method according to claim 20, wherein the NW element is configured to schedule resources within a first channel that includes at least a UL subband and a DL subband that is adjacent to the UL subband, the method further comprising:
in response to the UE capability information indicating a better Tx unwanted emission capability, determining the UL subband as the first UL resource and the DL subband being allocated to a second UE having either a better Rx ACS/blocking capability or a worse Rx ACS/blocking capability;
in response to the UE capability information indicating a worse Tx unwanted emission capability, determining the UL subband as the first UL resource and the DL subband being allocated to a third UE having a better Rx ACS/blocking capability;
in response to the UE capability information indicating a better Rx ACS/blocking capability, determining the DL subband as the first DL resource and the UL subband being allocated to a fourth UE having either a better Tx unwanted emission capability or a worse Tx unwanted emission capability; or
in response to the UE capability information indicating a worse Rx ACS/blocking capability, determining the DL subband as the first DL resource and the UL subband being allocated to a fifth UE having a better Tx unwanted emission capability.

22-29. (canceled)
